(19) United States
(12) Patent Application Publication
(10) Pub. No.: US 2007/0136989 A1
(43) Pub. Date: Jun. 21, 2007

(54) APPARATUS, SYSTEM, AND METHOD FOR PRESERVING A MORTISE

(76) Inventors: Joshua C. Lee, Fermington, UT (US); E. Kendall Lyman, Bountiful, UT (US)

Correspondence Address: Kunzler & McKenzie, 8 EAST BROADWAY, SUITE 600, SALT LAKE CITY, UT, 84111, US

(21) Appl. No.: 11/567,590

(22) Filed: Dec. 6, 2006

Related U.S. Application Data
(60) Provisional application No. 60/742,961, filed on Dec. 6, 2005.

(51) Int. Cl. E05D 7/10

(52) U.S. Cl. 16/254

(57) ABSTRACT

An apparatus and method are used for preserving a mortise. A guard for preserving a mortise includes an overlay configured to fill the mortise, an edge conforming to an indentation edge of the mortise, and a securing device configured to removeably attach the overlay within the mortise. The guard may further comprise a flange disposed on the overlay for placing and removing the guard from the mortise. The securing device may be configured for receiving a fastener or may include a protrusion configured to be received in a hole disposed in the mortise. The guard advantageously prevents paint from entering and damaging the mortise. A method for preserving a mortise includes providing a guard configured to fill the mortise, placing the guard on top of the mortise, and securing the guard within the mortise. Beneficially, the guard and method for preserving a mortise protects a mortise from exposure to paint.

### BACKGROUND OF THE INVENTION

1. Field of the Invention

This invention relates to tools and more particularly relates to guards for preventing surface exposure to paint.

2. Description of the Related Art

When painting walls, furniture, or the like, painters often use a variety of tools or mechanisms to prevent paint from contacting nearby surfaces, such as the trim next to a wall. Painters frequently use tape, paint shields, special brushes or rollers and the like to direct the paint to the desired surface and to prevent undesired contact with adjoining surfaces. These mechanisms generally work well for large level surfaces such as base boards and window panes.

Uneven paint surfaces with small protrusions or indentations, however, present additional problems when painting. First, paint shields and/or brushes usually are not sized to accommodate such conditions, generally leaving the protrusion and/or indentation unprotected during the painting process. Second, tape, which is flimsy and somewhat difficult to apply, can leave a sticky residue and usually does not sufficiently cover uneven surfaces. An example of a protrusion may be a hinge, and an example of an indention may be a mortise.

FIG. 1 depicts an exploded view of one embodiment of a standard hinge 100 and a hinge mortise 110. The hinge 100 generally includes a plurality of leaves 102, a joint 104 and/or pin connecting the leaves 102, holes 106, and a curved or decorative edge 108. The holes 106 may facilitate attaching the hinge 100 with a fastener to a surface 120 of an object, such as a door, door jamb, table or the like.

The mortise 110, which generally consists of a cut out cavity or an indentation 112 in the surface 120, corresponds to the leaf 102, as illustrated, and includes holes 114 that match up with the holes 106 of the hinge 100. A fastener (not shown) such as a screw or bolt may be inserted through the holes 106 and secured within the mortise holes 114. The mortise 110 enables the surface 120 to remain substantially flat when the hinge 100 is secured within the mortise 110.

Painting around the hinge 100 generally introduces some of the problems mentioned above. A paint shield is typically not sized to fit around the joint 104, and tape, if applied to the whole hinge 100, is usually difficult to apply and does not provide a well-defined edge. Paint additionally tends to seep between the hinge 100 and the mortise 110, essentially gluing the hinge 100 to the mortise 110 permanently, which may not be desirable.

As an alternative to covering the hinge 100, the hinge 100 may be removed to prevent contact with the paint. The mortise 110, however, may be susceptible to damage from the paint. In certain instances, paint accumulated within the mortise 110 fills in the indentation 112, thus deforming the mortise 110 and preventing proper insertion of the leaf 102. Particularly in situations where the hinge 100 is positioned between a door and a door jamb, a mal-fitted hinge 100 may cause the door to stick or may even prevent closing the door.

From the foregoing discussion, it should be apparent that a need exists for an apparatus and method that preserve a mortise by preventing paint from entering the mortise. Beneficially, such an apparatus and method would enable the removal and reinsertion of the corresponding element, such as the hinge 100, would provide a well-defined edge for painting the surface around the mortise, and would provide a temporary, non-damaging shield such that the corresponding element may be completely restored to its original configuration subsequent to the painting process.

### SUMMARY OF THE INVENTION

The present invention has been developed in response to the present state of the art, and in particular, in response to the problems and needs in the art that have not yet been fully solved by currently available paint guards. Accordingly, the present invention has been developed to provide an apparatus and method for preserving a mortise that overcome many or all of the above-discussed shortcomings in the art.

The apparatus, in one embodiment, comprises a guard with an overlay configured to fill a mortise, an edge conforming to an indentation edge of the mortise, and a securing device for securing the overlay within the mortise. The guard prevents paint from entering and damaging the mortise. In certain embodiments, the overlay may be shaped to resemble the leaf of a hinge. In addition, the overlay may comprise a flange to facilitate insertion of the overly within the mortise. In one embodiment, the overlay comprises a textured surface configured to prevent paint from running off of the overlay.

The securing device may be configured to retain the overlay within the mortise. In one embodiment, the securing device comprises a hole for receiving a fastener. In another embodiment, the securing device comprises a protrusion connected to the overlay. The protrusion may have flexible ridges to secure the protrusion within the hole of the mortise. In certain embodiments, the protrusion comprises an elastomeric plug. In yet another embodiment, the securing device comprises a fastener such as one or more staples, nails, screws, or the like. In a further embodiment, the hole is adapted to interchangeably receive an insert, such that the insert provides a protrusion or a flat plug that blocks the hole. In addition the securing device may comprise an adhesive or the like. Consequently, the overlay may be secured within the mortise during the painting process.

A method of the present invention is also presented for preserving a mortise. In one embodiment, the method includes providing a guard, placing the guard on top of the mortise, and securing the guard within the mortise. The method also may include painting around the guard and removing the guard from the mortise. Furthermore, the method of the present invention may comprise reusing the guard for preserving a second mortise.

Reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention may be practiced without one or more of the specific features or advantages of a particular embodiment. In other instances, additional features and advantages may be recognized in certain embodiments that may not be present in all embodiments of the invention.

These features and advantages of the present invention will become more fully apparent from the following description and appended claims, or may be learned by the practice of the invention as set forth hereinafter.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is an exploded view illustrating a mortise of a hinge;

FIG. 2 is a plan view illustrating one embodiment of a guard in accordance with the present invention;

FIG. 3 is a perspective view illustrating one embodiment of a guard with a through hole in accordance with the present invention;

FIG. 4 is a perspective view of the back of the guard of FIG. 3;

FIG. 5 is an exploded view illustrating one embodiment of the guard of FIG. 3 relative to a mortise in accordance with the present invention;

FIG. 6 is a perspective view of the guard of FIG. 3 secured to the frame of a door jamb in accordance with the present invention;

FIG. 7 is a perspective view illustrating one embodiment of a guard with a protrusion in accordance with the present invention;

FIG. 8 is a side view and a plan view illustrating in greater detail the guard of FIG. 7;

FIG. 9 is a perspective view illustrating one embodiment of a guard with a shaped protrusion in accordance with the present invention;

FIG. 10 is a side view and a plan view illustrating in greater detail the guard of FIG. 9;

FIG. 11 is a perspective view illustrating one embodiment of a guard with a protrusion having flexible ridges in accordance with the present invention;

FIG. 12 is a side view and a plan view illustrating in greater detail the guard of FIG. 11;

FIG. 13 is a perspective view illustrating one embodiment of a guard with a split protrusion having flexible ridges in accordance with the present invention;

FIG. 14 is a side view and a plan view illustrating in greater detail the guard of FIG. 13;

FIG. 15 is a perspective view illustrating one embodiment of a flat guard in accordance with the present invention

FIGS. 16-19 are perspective views illustrating various embodiments of a guard configured to cover a bolt hole in accordance with the present invention; and

FIG. 20 is a schematic flow chart diagram illustrating one embodiment of a mortise preservation method in accordance with the present invention.

### DETAILED DESCRIPTION OF THE INVENTION

Reference throughout this specification to “one embodiment,” “an embodiment,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided to give a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

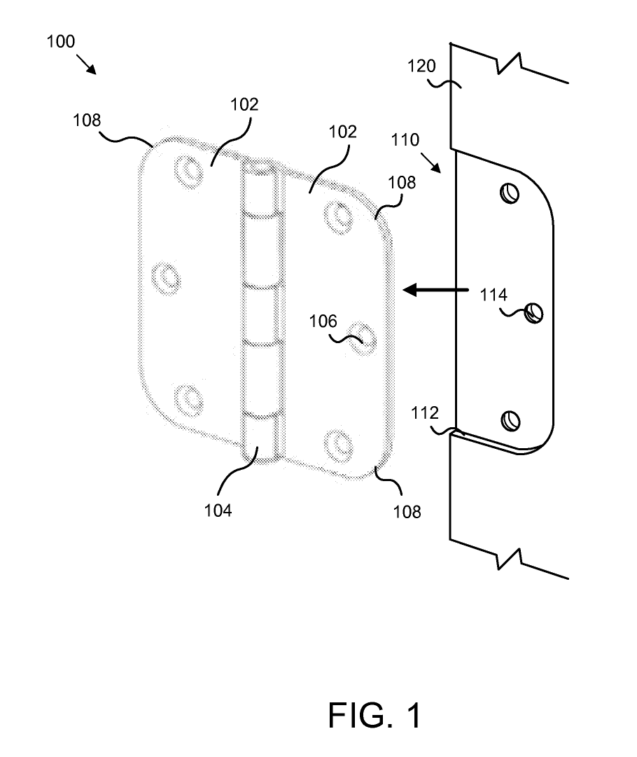

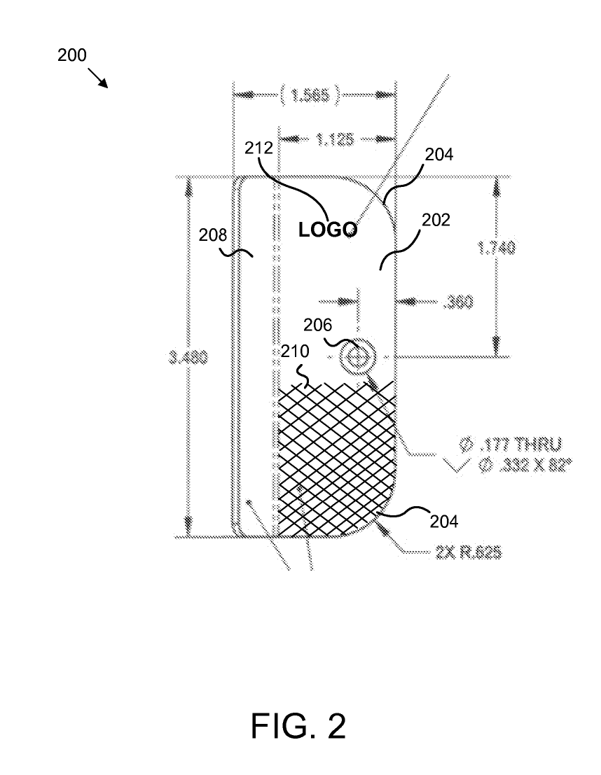

FIG. 2 illustrates one embodiment of a guard 200 for preserving the mortise 110 of FIG. 1. In the depicted embodiment, the guard 200 includes an overlay 202, an edge 204, a securing device 206, a flange 208, a textured surface 210, and a symbolic element 212. The guard 200 may be sized to resemble the corresponding element that fits within the mortise 110, such as the hinge leaf 102 in the illustrated embodiment. In one aspect, the guard 200 may resemble a “dummy” corresponding element to prevent paint from filling in the indentations 112 or from contacting the mortise 110. The guard 200 may have any size or shape to correspond to the mortise 110.

In the depicted embodiment, the overlay 202 is a thin, rectangular plate with a lip-like fin or flange 208 extending at an obtuse angle from one side. The flange 208 extends the length of the overlay 202. The opposing side of the overlay 202 has a straight edge 204 that transitions at radial corners to perpendicular top and bottom edges 204. The securing device 206 comprises a countersink hole disposed centrally within the overlay 202. The counter sink hole may be positioned centrally relative to the length of the overlay 202. In one embodiment, given by way of example, the overlay 202 is 1.125 inches wide by 3.480 inches long.

The overlay 202 may be made from any material suitable for preventing paint from contacting the mortise 110. In certain embodiments, the overlay 202 may be a rigid or semi-rigid material. In one embodiment, the overlay 202 is made from a biodegradable plastic. In an alternative embodiment, the overlay 202 may be made of an elastomeric material or rubber. In a contemplated embodiment, the overlay 202 may be made from wood or metal. Those of skill in the art will recognize that suitable materials are not limited to those described.

The guard 200 may be intended for single use or may be reusable. The material may be selected to resist paint accumulation such that the user may be able to easily clean the guard 200. Alternatively, the guard 200 may be disposable.

As mentioned, the overlay 202 may be sized to match to the corresponding element of the mortise 110. Consequently, the edge 204 of the overlay 202 may correspond to the edge 108 of the leaf 102 or the like in order to create a tight fit within the mortise 110.

In certain embodiments, the edge 204 may be formed into a variety of shapes to fit a specific mortise 110. In one embodiment, the overlay 202 is made from a semi-rigid material that may be cut with a razor or the like, thereby enabling the user to shape the edge 204 to correspond with a specific mortise 110. In certain embodiments, the overlay 202 may comprise multiple sections that fit together to fill the mortise 110. Those of skill in the art will recognize that the overlay 202 may be constructed from a variety of materials and that the edge 204 may be formed or modified using a variety of methods.

The guard 200 may further include the securing device 206 to secure the overlay 202 within the mortise 110. In the depicted embodiment, the securing device 206 comprises a hole 206 disposed within the overlay 202 that is substantially aligned with the hole(s) 114 of the mortise 110. As a result, the guard 200 may be secured to the mortise 110 with a fastener such as a screw or the like.

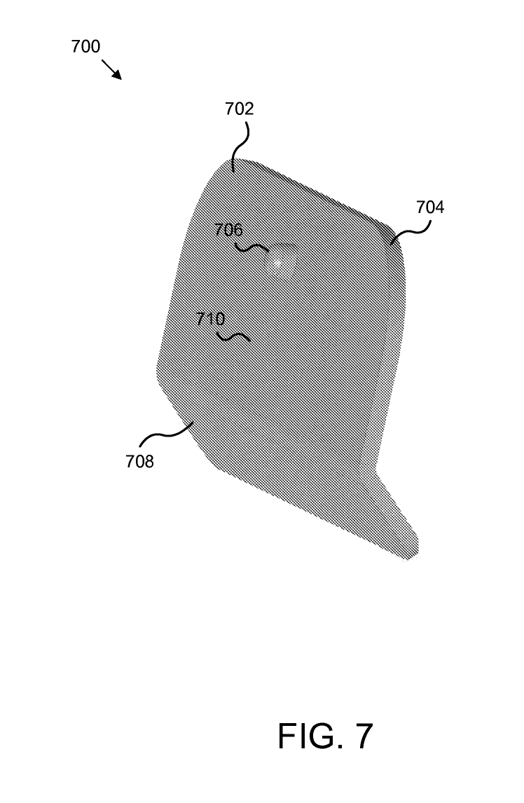

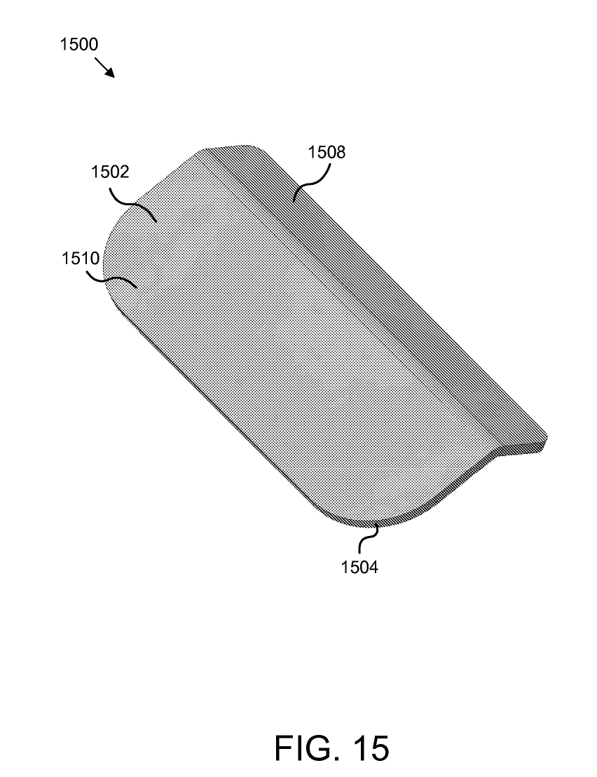

Alternatively, the overlay 202 may comprise one or more protrusions, which will be discussed in greater detail with relation to FIGS. 7-19. In one embodiment, the overlay 202 is flat and is secured to the mortise 110 with a nail, staple, adhesive or the like, which will be discussed with relation to FIG. 15.

In a contemplated embodiment, the securing device 206 enables the guard to be easily secured to and removed from the mortise 110 without permanently altering the mortise 110. In addition, the securing device 206 and/or the guard 200 preferably do not obstruct or cover the surface 120 designated to be painted. In certain embodiments, the overlay 202 may be secured with an adhesive or the like, in addition to or in place of another type of fastener. In one embodiment, the back of the overlay 202 may be coated with an adhesive or bonding agent, which may be protected by a peel-off backing.

The flange 208 may be disposed on the overlay 202 and may facilitate insertion and removal of the guard 200 by providing a handle or grip for the user. In certain embodiments, the flange 208 extends the length of the overlay 202. Alternatively, the flange 208 may span a portion of the overlay 202. In one embodiment, the flange 208 is attached to the top surface of the overlay 202. The flange 208 may be molded with the overlay 202 in certain embodiments. Alternatively, the flange 208 may be made separately and may be attached to the overlay 202.

In one embodiment, the flange 208 is removable and may include a fastener such as a snap, hook, hook and loops, or the like. Those of skill in the art will recognize that the flange 208 may be made from a variety of materials and may be disposed on the overlay 202 in a variety of positions and/or configurations and is not, therefore, limited to the illustrated embodiments.

The overlay 202 may include the textured surface 210 or the like to facilitate the painting process. The textured surface 210 may prevent paint from conglomerating and running or dripping onto the painted surface 120. In one embodiment, the surface of the overlay 202 is coated with a textured residue. Alternatively, the surface of the overlay 202 may be roughened or imprinted with a textured pattern.

The guard 200 may further include a symbolic element 212, such as a logo, company information, labels, product discounts, instructions, etc., to present a message. In one embodiment, the symbolic element 212 is molded into the overlay 202. In an alternative embodiment, the symbolic element 212 is printed on a label or the like and attached to the guard 200 after the manufacturing process. In certain embodiments, the symbolic element 212 enables the paint guard 200 to function as an advertisement to promote a business and/or its products.

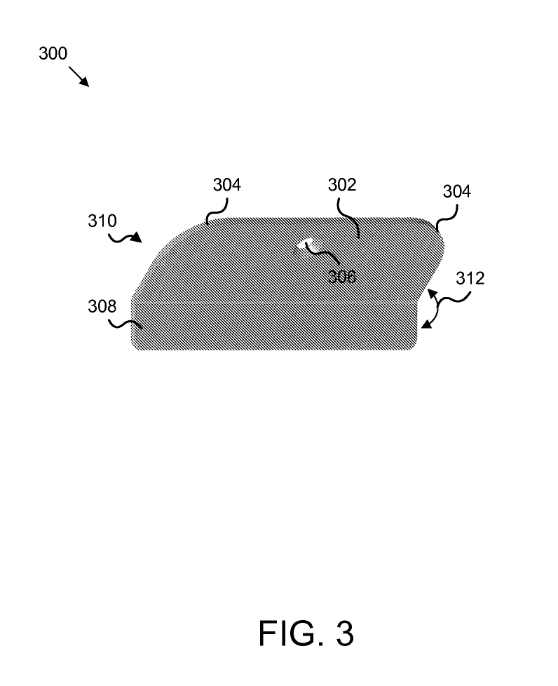

FIG. 3 illustrates one embodiment of a guard 300 with an overlay 302, an edge 304, a hole 306, and a flange 308. The overlay 302 may comprise a flat back surface 310 for contacting the mortise 110. The hole 306 may comprise a countersink hole 306 that extends through the overlay 302 to facilitate securing the guard 300 within the mortise 110 with a fastener. In certain embodiments, the guard 300 may comprise any number of holes 306, preferably not to exceed the number holes 114 in the selected mortise 110. The hole(s) 306 may be any variety of types and/or sizes. Alternatively, the guard 300 may be flat without any holes 306. In such an embodiment, the guard 300 may be attached with an adhesive and/or with staples, nails, self-tapping screws or the like. Likewise, the guard 300 may have hole(s) 306 adapted to interchangeably receive an insert. The insert could be a protrusion 706 of FIG. 7, a protrusion with flexible ridges 1106 of FIG. 11, an adhesive plug, or a flat plug designed to fill the hole 306.

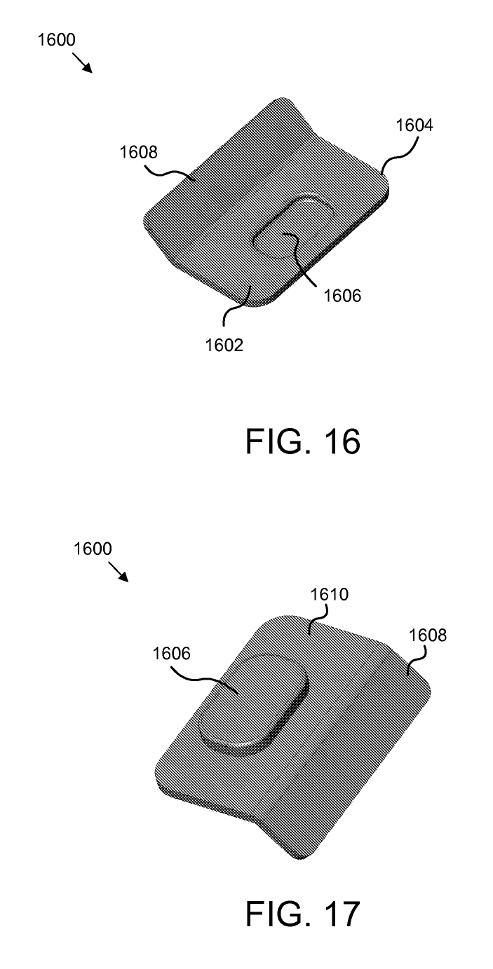

In one embodiment, the guard 300 may be configured to fit within the mortise (not shown) of a door jamb designated for receiving the bolt of a door lock. In such an embodiment, the guard 300 may comprise a pair of holes 306 to align with the holes of the mortise. Alternatively, the guard 300 may comprise a protrusion and/or a tenon to fit into the bolt cavity as illustrated in FIGS. 16-19. The guard 300 may be configured to fit into a variety of mortises and is not, therefore, limited to the mortises of hinges or door jambs as discussed.

In the depicted embodiment, the flange 308 is attached to the side of the overlay 302 at an angle 312. In an alternative embodiment, the flange 308 may extend directly from the overlay 302. In one embodiment, the flange 308 may comprise a knob in the center of the overlay 302 or the like.

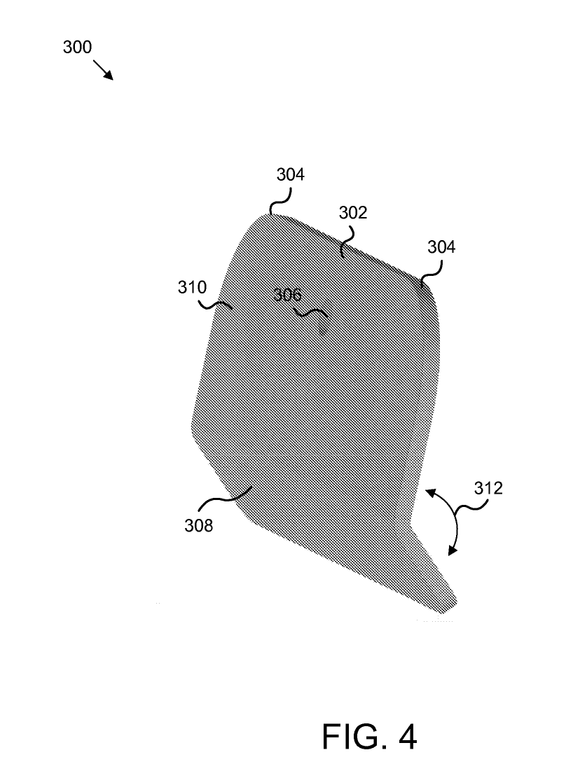

FIG. 4 illustrates a back view of the guard 300 of FIG. 3. The back surface 310 may be flat to facilitate a tight fit within the mortise 110. The edges 304 may further be shaped to correspond to the mortise 110. In addition, the thickness of the overlay 302 may or may not correspond to the thickness of the leaf 102 or the corresponding element. Adhesive or the like may be applied to the back surface 310 as discussed.

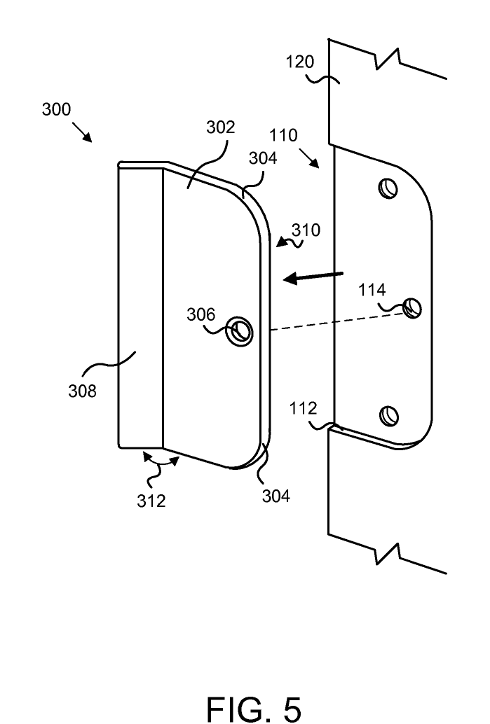

FIG. 5 illustrates the guard 300 of FIG. 3 relative to the mortise 110 illustrated in FIG. 1. The guard 300 fits within the mortise 110 and may be secured with a fastener through the hole 306 and the hole 114. The guard 300 fills the mortise 110, preventing paint from entering the mortise 110. The edge 304 may provide a defined edge for painting the surface 120. In addition, the edge 304 may or may not be filleted to accommodate errors in the manufacture of the mortise 110.

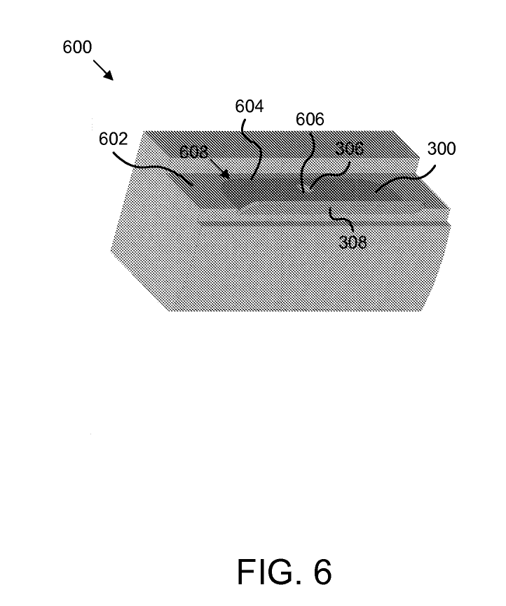

FIG. 6 illustrates one embodiment of the guard 300 attached to the frame 602 of a door jamb 600. The frame 602 may comprise a mortise 604, which may be similar to the mortise 110 illustrated in FIG. 1 and FIG. 5. The guard 300 may be attached to the door frame 602 with a screw 606 or the like through the countersink hole 306. The flange 308 may be used to stabilize the guard 300. In one embodiment, when the guard 300 is secured within the mortise 604, the guard 300 fills in the indentation 112 to create a substantially even surface 608 with the frame 602, thereby protecting the mortise 604.

FIG. 7 illustrates one embodiment of a guard 700 with a protrusion 706. The guard 700 may include an overlay 702, a curved edge 704, a securing device or protrusion 706, a flange 708, and a flat back surface 710. The protrusion 706 may be disposed on the back surface 710 of the overlay 702 and may correspond to the hole 114 of the mortise 110. The protrusion 706 may be formed integral with the overlay 702 or may be fabricated separately and then attached to the overlay 702. In one embodiment, the protrusion 706 is made of an elastomer and formed into an elastomeric plug 706. In another embodiment, the protrusion 706 is made of molded plastic. In a contemplated embodiment, the protrusion 706 has a gripping quality to facilitate securing the overlay 702 within the mortise 110. The protrusion 706 may eliminate the need for an additional fastener.

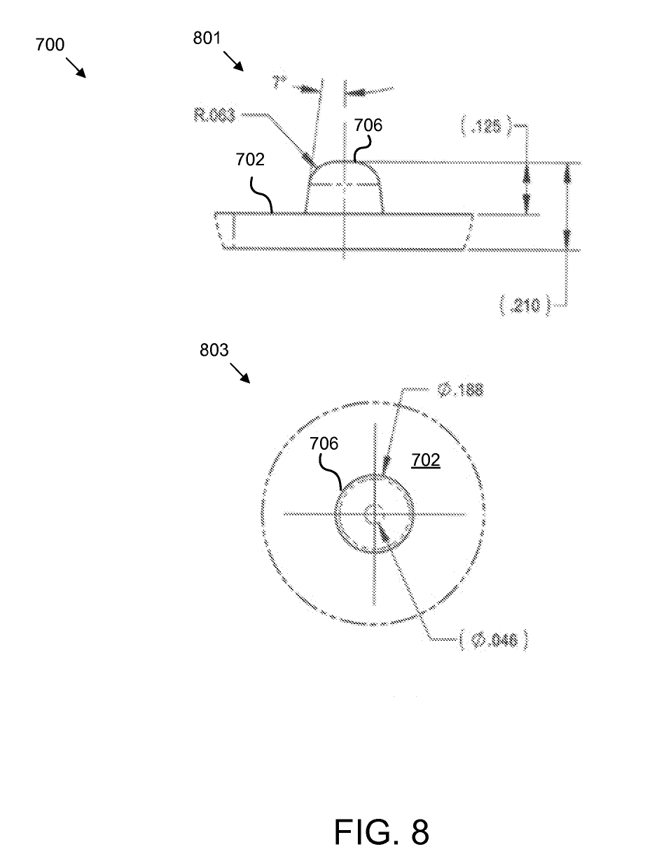

FIG. 8 illustrates a side view 801 and a plan view 803 of the protrusion 706 of FIG. 7. The protrusion 706 may be conical and sized to fit within the hole 114. In a contemplated embodiment, the protrusion 706 secures the overlay 702 within the mortise 110 without damaging the mortise 110 or the hole 114.

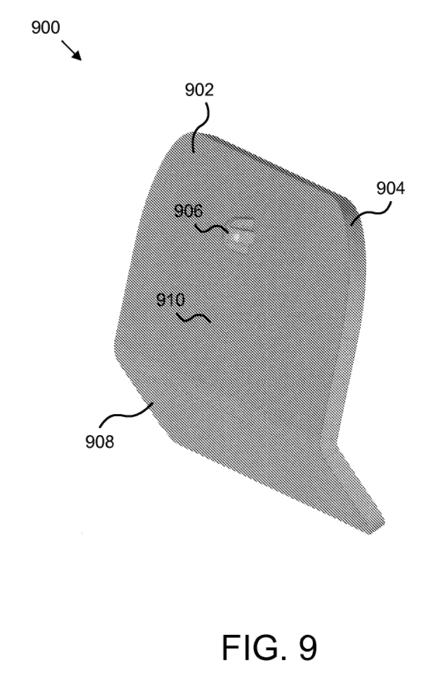

FIG. 9 illustrates one embodiment of a guard 900 with a shaped protrusion 906. The guard 900 may include an overlay 902, a curved edge 904, a securing device or protrusion 906, a flange 908, and a back surface 910. As mentioned, the protrusion 906 may be disposed on the back surface 910 of the overlay 902 and may correspond to the hole 114 of the mortise 110. The protrusion 906 may be shaped, such as to resemble a square, cross, star, diamond, octagon, or the like, in order to create a tension fit within the hole 114. In addition, the overlay 902 may comprise as many protrusions 906 as holes 114 available in the mortise 110 in certain embodiments. Furthermore, if the mortise 110 comprises a larger cavity, such as for a door bolt, for example, the protrusion 906 may be sized to create a tension fit within the cavity.

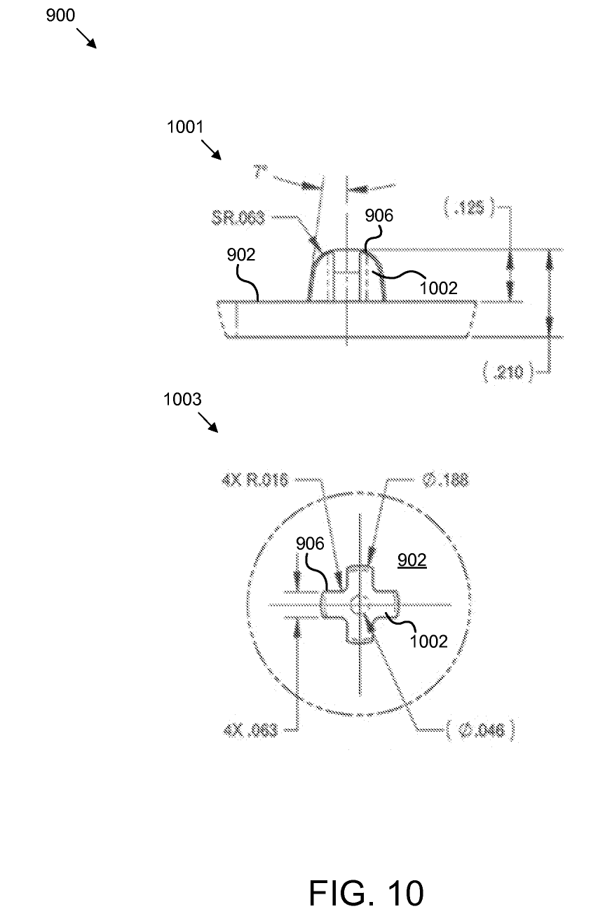

FIG. 10 illustrates a side view 1001 and a plan view 1003 of the protrusion 906 of FIG. 9. The protrusion 906 may include extensions 1002, which may form a cross, and may be sized to fit within the hole 114. The protrusion 906 facilitates securing the overlay 902 within the mortise 110.

FIG. 11 illustrates one embodiment of a guard 1100 with a protrusion 1106 with ridges 1112. The guard 1100 may include an overlay 1102, a curved edge 1104, a securing device or protrusion 1106, a flange 1108, and a back surface 1110. The ridges 1112 may be flexible and may provide additional surface area for gripping or for providing tension within the hole 114.

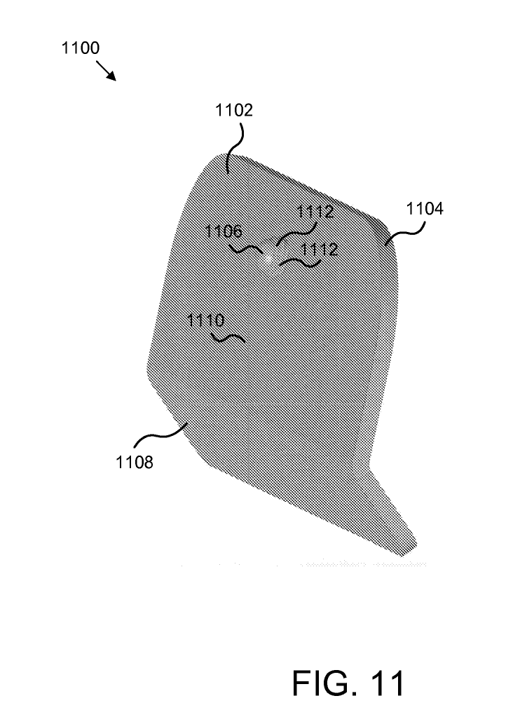

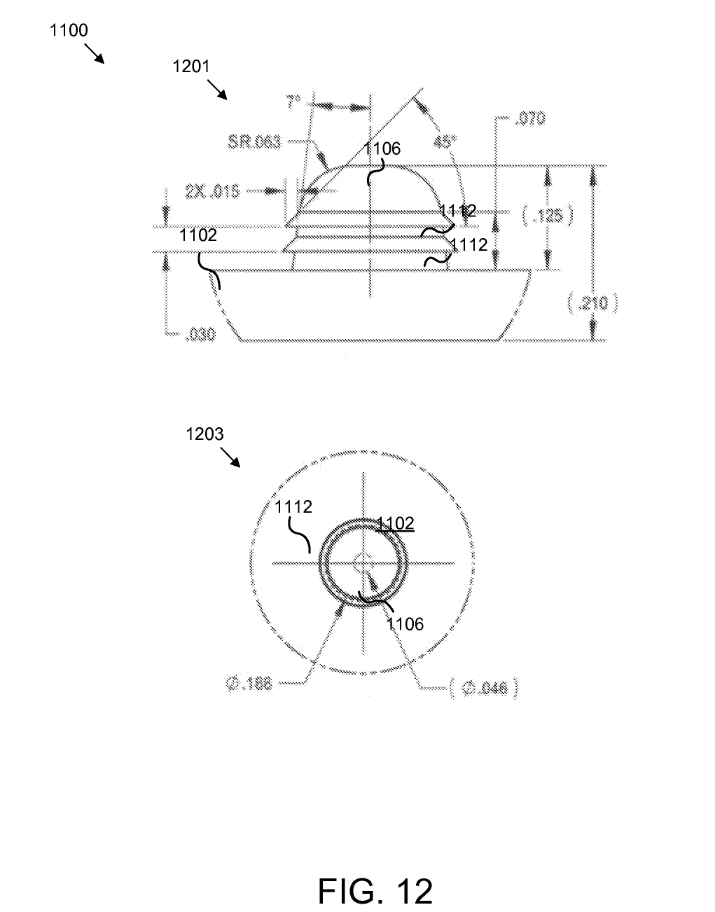

FIG. 12 illustrates a side view 1201 and a plan view 1203 of the protrusion 1106 of FIG. 11. The ridges 1112 may protrude from the protrusion 1106 and may be angled to enable easy insertion of the protrusion 1106 within the hole 114. The ridges 1112 may flare out to provide tension, thereby preventing the protrusion 1106 from accidentally falling out of the hole 114. Yet, the guard 1100 may be easily removed with applied force. In addition, the flexible ridges 1112 may grip the threads of the hole 114 for anchorage, but may be removed without damaging the original structure of the hole 114.

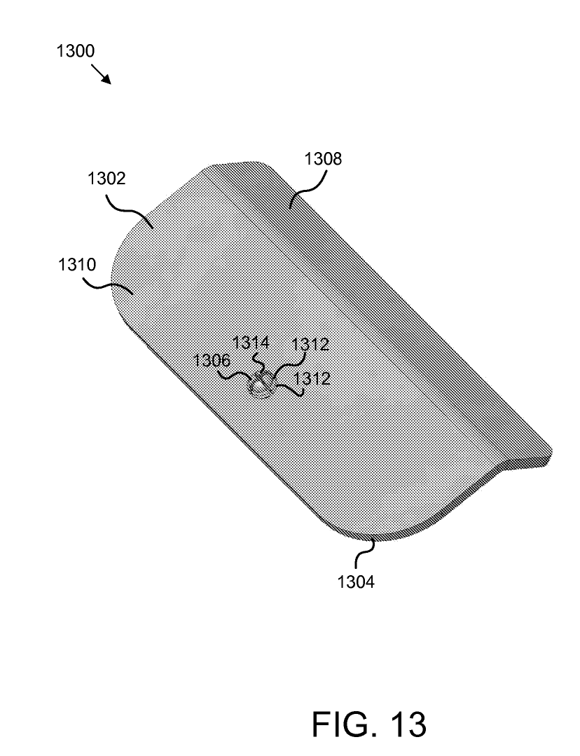

FIG. 13 illustrates one embodiment of a guard 1300 with a protrusion 1306 with ridges 1312. The guard 1300 may include an overlay 1302, a curved edge 1304, a securing device or protrusion 1306, a flange 1308, and aback surface 1310. The ridges 1312 may be similar to ridges 1112 illustrated in FIGS. 11-12. In the depicted embodiment, the protrusion 1306 is divided into sections 1314. Sections 1314 may contribute to the flexible nature of the protrusion 1306. In certain embodiments, the sections 1314 may be adjustable to adapt to different-sized holes 114. In one embodiment, the sections 1314 may be implemented with a rail and locking system to adjust the position and the lock the section 1314 into place. In certain embodiments, the section 1314 may be used in conjunction with a spring to position the section 1314 against the interior of the hole 114 or the like.

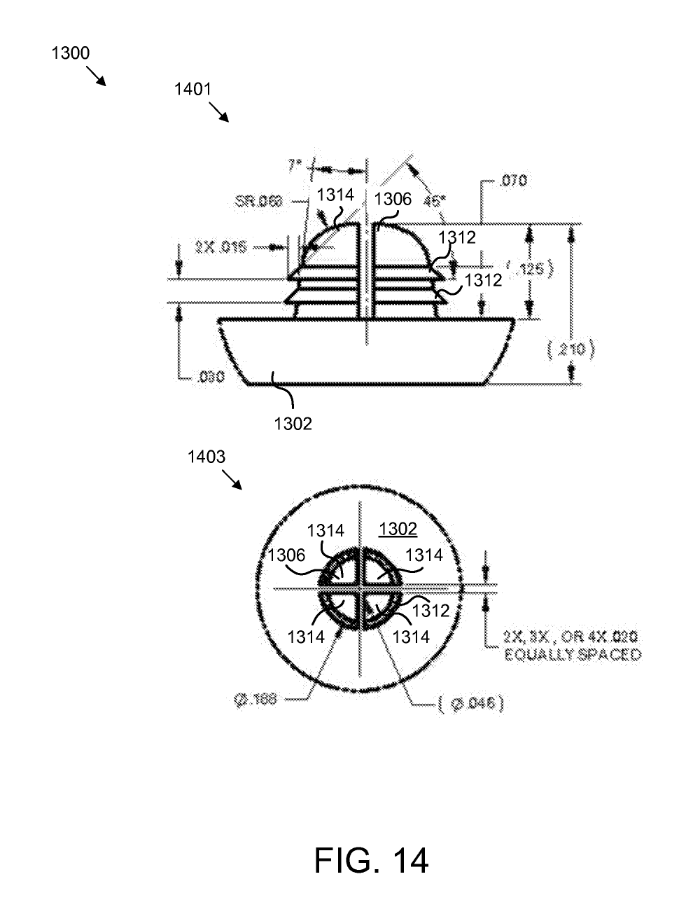

FIG. 14 illustrates a side view 1401 and a plan view 1403 of the protrusion 1306 of FIG. 13. The sections 1314 may provide greater flexibility in inserting the protrusion 1306 into the hole 114. The space between the sections 1314 enables the sections 1314 to give inward and flex back to engage the interior of the hole 114 with a tight friction fit. The sections 1314 may be made of a flexible material to enable the protrusion 1306 to fit into variously-sized holes 114.

FIG. 15 illustrates one embodiment of a flat guard 1500 without holes 306 or protrusions 706. The guard 1500 may include an overlay 1502, a curved edge 1504, a flange 1508, and a back surface 1510. The guard 1500 may form a friction fit within the mortise 110. In certain embodiments, the edge 1504 may comprise an elastomer lining, protrusion, or the like to grip the interior of the indentation 112, thereby securing the guard 1500 within the mortise 110. Alternatively, the flat guard 1500 may be secured to the mortise 110 with one or more staples, nails, screws, an adhesive, a protrusion disposed on the edge 1504, or the like. Those of skill in the art will recognize that the guard 1500 may be secured within the mortise 110 using a various methods and mechanisms.

FIG. 16 and FIG. 17 illustrate one embodiment of a guard 1600 suitable for covering a mortise of a bolt hole or the like. The guard 1600 as depicted includes an overlay 1602, a curved edge 1604, securing device or protrusion 1606, a flange 1608, and a back surface 1610. The overlay 1602 and the curved edge 1604 may be configured to fill the mortise of a doorjamb for receiving a bolt. In the depicted embodiment, the securing device 1606 comprises a protrusion from the overlay 202 sized similar to a bolt, which may be inserted into the bolt hole. As discussed above, the securing device 1606 may be any mechanism suitable for securing the overlay 1602 within the mortise.

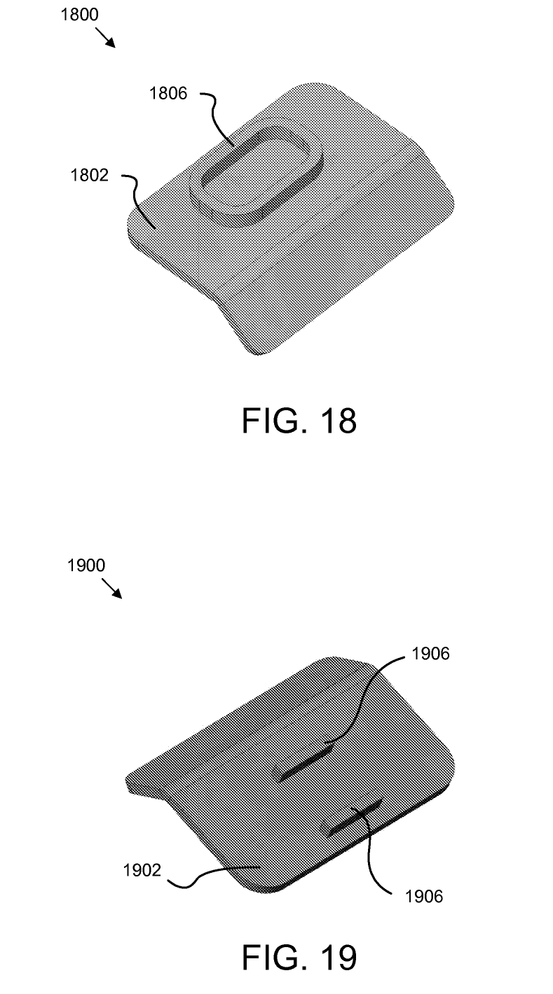

FIG. 18 and FIG. 19 illustrate various embodiments of securing devices for securing a guard 1800 and a guard 1900 respectively within a mortise. The guard 1800 includes an overlay 1802 with a protruding, hollowed-out securing device 1806 configured to fit within a bolt hole. The guard 1900 includes a plurality of protrusions 1906 to retain the overlay 1902 within the mortise. The protrusions 1906 may be adjustable to fit various sizes of holes.

The schematic flow chart diagram that follows is generally set forth as a logical flow chart diagram. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

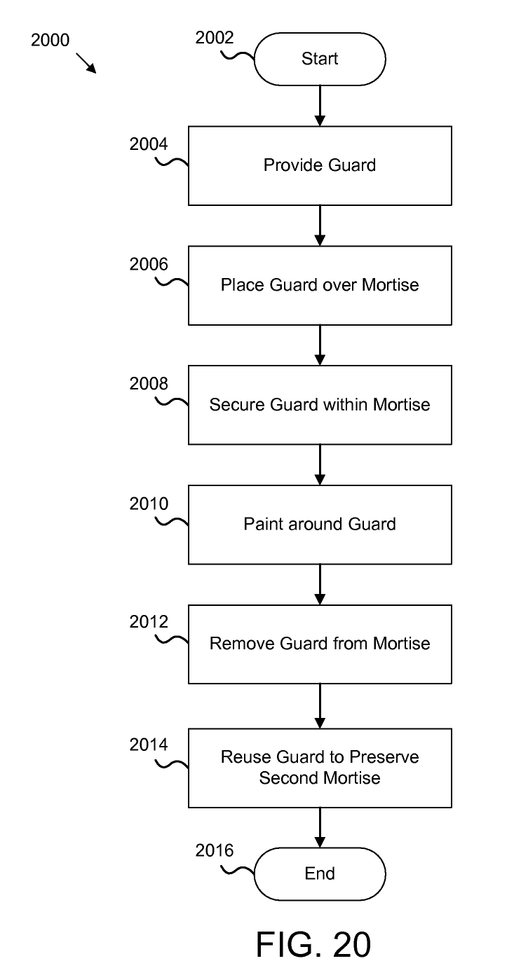

FIG. 20 illustrates one embodiment of a mortise preservation method 2000 in accordance with the present invention. The method 2000 may begin 2002 and may include providing 2004 a guard, placing 2006 the guard over a mortise, securing 2008 the guard within the mortise, painting 2010 around the guard, and removing 2012 the guard from the mortise. The method 2000 enables a surface 120 near a mortise 110 to be painted without damaging the mortise 110. Reference may be made to FIGS. 1-19 to illustrate the method 2000 in greater detail, but does not limit the scope of the method 2000.

In one embodiment, a guard such as the guard 200 is provided 2004 and is shaped to correspond with the mortise 110 of the hinge 100. The edges 204 of the overlay 202 may provide a close fit with the wall or indentation 112 of the mortise 110. Subsequently, the guard 200 may be placed 2006 over the mortise 110. In certain embodiments, the outer surface of the overlay 202 lies even with the surrounding surface 120. The flange 208 may facilitate placing 2006 the guard over the mortise 110. The hole 206 or the protrusion 706 or the like may facilitate securing 2008 the guard 200 within the mortise 110. Alternatively, the guard 200 or guard 1500 may be secured with an adhesive, staples, nails, or the like. Moreover, the edge 204 may additionally be secured to the wall or indentation 112, in certain embodiments, using fasteners, adhesives, protrusions, linings, or the like.

The user may paint 2010 around or over the guard 200 in certain embodiments. The paint may be allowed to dry before removing 2012 the guard 200 from the mortise 110. In certain embodiments, the fastener 606 may be removed before removing 2012 the guard 200. The method may further comprise reusing 2014 the guard to preserve a second mortise. Then the method 2000 ends 2016.

The indentation 112 of the mortise 110 remains free of paint, and the hinge 100 or other corresponding element may be replaced within the mortise 110. In certain embodiments, the guard 200 may be discarded or recycled. Alternatively, the guard 200 may be saved for further use. The surface 120 may be painted with well-defined edges and without damaging the mortise 110 or the corresponding element.

The present invention may be embodied in other specific forms without departing from its spirit or essential characteristics. The described embodiments are to be considered in all respects only as illustrative and not restrictive. All changes which come within the meaning and range of equivalency of the claims are to be embraced within their scope.

What is claimed is:

1. A guard for preserving a mortise, the guard comprising:
an overlay configured to fill the mortise;
an edge conforming to an indentation edge of the mortise; and
a securing device configured to removeably attach the overlay within the mortise.

2. The guard of claim 1, further comprising a flange disposed on the overlay.

3. The guard of claim 1, wherein the securing device comprises a hole for receiving a fastener.

4. The guard of claim 1, wherein the securing device comprises a protrusion connected to the overlay.

5. The guard of claim 4, wherein the protrusion comprises an elastomeric plug.

6. The guard of claim 4, wherein the protrusion has flexible ridges.

7. The guard of claim 3, wherein the hole is adapted to interchangeably receive an insert, the insert selected from the group consisting of a protrusion, a protrusion having flexible ridges, an elastomeric plug, an adhesive plug, and a flat plug.

8. The guard of claim 1, wherein the overlay is shaped to resemble a leaf of a hinge.

9. The guard of claim 1, wherein the overlay comprises a textured surface configured to prevent paint from running off of the textured surface.

10. The guard of claim 1, wherein the securing device comprises a lining configured to contact and grip the mortise.

11. A guard for preserving a mortise, the guard comprising:
an overlay configured to fill the mortise;
an edge conforming to an indentation edge of the mortise;
a flange disposed on the overlay for placing and removing the guard from the mortise; and
a securing device configured to removeably attach the overlay within the mortise.

12. The guard of claim 11, wherein the securing device is one of a group consisting of a hole for receiving a fastener, a protrusion, a protrusion with flexible ridges, an elastomeric plug, adhesive, staples, nails, and screws.

13. The guard of claim 12, wherein the overlay is shaped to resemble a leaf of a hinge.

14. The guard of claim 13, wherein the overlay comprises a textured surface configured to prevent paint from running off of the textured surface.

15. The guard of claim 12, further comprising a plurality of securing devices.

16. The guard of claim 11, wherein the securing device comprises a lining configured to contact and grip the mortise.

17. A method for preserving a mortise, the method comprising:
providing a guard, the guard comprising an overlay configured to fill the mortise;
providing a securing device configured to removeably attach the overlay within the mortise;
placing the guard on top of the mortise; and
securing the guard within the mortise.

18. The method of claim 17, further comprising painting around the guard.

19. The method of claim 17, further comprising removing the guard from the mortise

20. The method of claim 17, further comprising reusing the guard for preserving a second mortise.
